(19) United States
(12) Patent Application Publication
(10) Pub. No.: US 2022/0146264 A1
(43) Pub. Date: May 12, 2022

(54) METHOD AND SYSTEM FOR ESTIMATING STATE VARIABLES OF A MOVING OBJECT WITH MODULAR SENSOR FUSION

(71) Applicant: Alpen-Adria-Universität Klagenfurt, Klagenfurt am Wörthersee (AT)

(72) Inventors: Christian Brommer, Werne (DE); Stephan Michael Weiss, Klagenfurt am Wörthersee (AT)

(21) Appl. No.: 17/521,157

(22) Filed: Nov. 8, 2021

(30) Foreign Application Priority Data
Nov. 10, 2020 (AT) A50969/2020

(51) Int. Cl. G01C 21/20

(52) U.S. Cl. CPC G01C 21/20

(57) ABSTRACT

A computer-implemented method is provided for estimating state variables of a moving object, which includes: propagating core state variables of the moving object utilizing a recursive Bayesian filter and observation values from sensors from start-up of the moving object; forming, utilizing observation values from one or more additional sensors added after start-up, a covariance matrix of the recursive Bayesian filter; updating the covariance matrix based on observation values formed by at least one additional sensor; and, ascertaining the covariance of the core state variables of the additional sensor at a time after start-up.

### FIELD OF THE INVENTION

The present invention relates to a computer-implemented method, a system and computer-readable storage medium for estimating state variables of a moving object, in which a modular sensor fusion approach is taken. Sensor fusion is also defined as sensor data fusion or as multi-sensor data fusion.

### BACKGROUND OF THE INVENTION

The estimation of state variables forms an essential part of both robotics and other engineering disciplines such as e.g. control engineering. For instance, the exact location of a robot platform is e.g. essential for the control and navigation thereof.

Most state estimators are dedicated state estimators which have been developed for a specific task on a specific robot platform under specific conditions and thus have a low re-usability in the event that the scenario, in particular the sensors or robot platform used, changes.

This problem is addressed by known so-called extended Kalman filter systems. Extended Kalman filters are recursive filters. However, the known extended Kalman filter systems also proceed from a sensor configuration which is defined during the compilation or start-up phase of the extended Kalman filter system. The reference frames of additional sensors are generally predefined and are not dynamically adapted to a changing scenario or a changing situation. The reference frames predefined in this way typically do not allow sensor initialization during the running time, particularly not if the sensor definition is not known to the system from the outset.

This limits the applicability of such extended Kalman filter systems to static hardware configurations, while suitability for modular hardware platforms, which are extended during the running time by further modules not known in advance, is rather low. Interconnectable snake robots and humanoid robots with interchangeable gripping organs are examples of such modular hardware platforms, of which the configuration/structure can change after they are launched.

For the integration of additional sensors added during the running time, calibration state variables must additionally be taken into account, since the additional sensors are generally neither oriented with the body frame, i.e. the object-related coordinate system, of the hardware or robot platform, nor are they intrinsically calibrated. The number of calibration state variables increases with the number of additional sensors. Alternatively, assumptions must be made regarding the invariability of the initial calibration of the additional sensors. Both make the regular, non-modular extended Kalman filter approach complex and inflexible. An increasing number of state variables results in more operations or calculation steps having to be carried out for the state estimation, e.g. in the propagation and correction/updating of system state variables. In the case of so-called naïve state estimators, i.e. state estimators which do not consider the modularity of the sensors or simplifying assumptions; the processing time increases cubically, i.e. with the order O(n³), with the number of sensors n due to the required matrix multiplications. For delayed or out-of-series measurement signals, this effect increases in a multi-sensor system even further, since delayed measurement signals trigger numerous recalculation steps. Hardware synchronisation can mitigate this problem, but this cannot be carried out in every case, e.g. not with dynamic sensor measurement rates with sensors which in essence do not provide this from the manufacturer. In addition, hardware synchronisation is generally associated with not inconsiderable technical outlay and the fundamentally delayed signal, now provided with a correct time stamp, can still trigger numerous recalculation steps.

Non-recursive filter systems which are based on e.g. graph optimization can initialize sensors, which are unknown in advance, during the running time of the system. However, their computing power requirements are generally so high that they are not suitable for use on resource-limited platforms, such as drones or small, lightweight robots in general.

State estimation with predefined configuration of multiple sensors and consideration of supplementary calibration state variables including their self-calibration and delay compensation has been addressed in the relevant literature. For instance, the Single Sensor Fusion Framework (SSF) which is proposed in “Real-time metric state estimation for modular vision-inertial systems,” by S. Weiss and R. Y. Siegwart, Proceedings—IEEE International Conference on Robotics and Automation, vol. 231855, pages 4531-4537, 2011, addresses both online self-calibration and accurate handling of sensor delays. An extended version of SSF was used in “Long-duration autonomy for small rotorcraft UAS including recharging,” by C. Brommer, D. Malyuta, D. Hentzen, and R. Brockers in 2018 IEEE/RSJ International Conference on Intelligent Robots and Systems (IROS), October 2018, pages 7252-7258, in a multi-sensor configuration for long-duration autonomy. S. Lynen, M. W. Achtelik, S. Weiss, M. Chli, and R. Siegwart, “A robust and modular multi-sensor fusion approach applied to MAV navigation,” in 2013 IEEE/RSJ International Conference on Intelligent Robots and Systems, November 2013, presents a Multi-Sensor Fusion Framework (MSF). In S. Shen, Y. Mulgaonkar, N. Michael, and V. Kumar, “Multi-sensor fusion for robust autonomous flight in indoor and outdoor environments with a rotorcraft MAV,” Proceedings—IEEE International Conference on Robotics and Automation, pages 4974-4981, 2014, a similar approach is taken, which presents relative and absolute sensor updates using the examples of local visual updates and global position information. While both SSF and MSF can account for sensor failures, “Self-calibrating multi-sensor fusion with probabilistic measurement validation for seamless sensor switching on a UAV,” by K. Hausman, S. Weiss, R. Brockers, L. Matthies, and G. S. Sukhatme, Proceedings—IEEE International Conference on Robotics and Automation, vol. 2016-June, pages 4289-4296 extends the MSF approach and describes online sensor initializations and switch-overs based on sensor availability and health metrics.

C. Tessier, C. Cariou, C. Debain, F. Chausse, R. Chapuis, and C. Rousset, “A real-time, multi-sensor architecture for fusion of delayed observations: application to vehicle localization,” in 2006 IEEE Intelligent Transportation Systems Conference, https://doi.org/10.1109/itsc.2006.1707405 propose a method for handling delayed measurement signals, which has been developed for computationally limited embedded systems. T. Moore and D. Stouch, “A generalized extended kalman filter implementation for the robot operating system,” in Proceedings of the 13^{th} International Conference on Intelligent Autonomous Systems (IAS-13), Springer, July 2014, describe a generalised extended Kalman filter implementation based on the so-called Robot Operating System (ROS). The sensor structure is defined at start-up. Modifications are not possible during the running time. It is assumed that sensor measurement values relate to the origin of the robot coordinate system. Neither sensor calibration nor online self-calibration are described. In the case of the Inertial Measurement Unit (IMU), there is no estimation of gyroscopic bias. Process noise is compensated for manually.

M. Darms and H. Winner, “A modular system architecture for sensor data processing of ADAS applications,” IEEE Intelligent Vehicles Symposium, Proceedings, vol. 2005, pages 729-734, 2005, describes the current state of science and technology in relation to centralised and decentralised systems which use sensor fusion for driving assistance in advanced driver-assistance systems (ADAS) deployed in vehicles. Centralised approaches permit a tightly coupled estimation but require high communication bandwidth and are difficult to extend to other applications. The workload for integrating new sensors is high. Decentralised systems use loosely coupled sensors, which has the disadvantage of inconsistencies by reason of inadequate handling of cross-covariances of sensor and core state variables.

D. A. Cucci and M. Matteucci, “On the Development of a Generic Multi-Sensor Fusion Framework for Robust Odometry Estimation,” Journal of Software Engineering for Robotics, vol. 5, May edition, pages 48-62, 2014, and H.-P. Chiu, X. S. Zhou, L. Carlone, F. Dellaert, S. Samarasekera, and R. Kumar, “Constrained optimal selection for multi-sensor robot navigation using plug-and-play factor graphs,” in 2014 IEEE International Conference on Robotics and Automation (ICRA), IEEE, May 2014, deal with the modularisation of multi-sensor fusion and propose a vector graph-based method using a real-time batch optimization process. The focus is on the optimal selection of a minimum subset from the given sensor configuration and observability for the sensor selection. However, the use of vector graph-based methods is disadvantageous in terms of scalability, particularly in combination with computationally limited resources.

Furthermore, WO 2015/105597 A1, U.S. Pat. No. 9,031,782 B1, U.S. Pat. No. 7,181,323 B1, U.S. Pat. No. 10,274,318 B1 describe known methods for sensor data fusion and position estimation which use an extended Kalman filter (EKF). With respect to sensor fusion, reference is also made to the following documents: Emter, T. et al.: “Stochastic Cloning for Robust Fusion of Multiple Relative and Absolute Measurements”, 2019 IEEE Intelligent Vehicles Symposium (IV), 9 Jun. 2016 (09.06.2019), pages 1782-1788, XP033606100; Asadi, E. et al.: “Delayed Fusion of Relative State Measurements by Extending Stochastic Cloning via Direct Kalman Filtering”, ISIF 16th International Conference on Information Fusion, 9 Jul. 2013 (09.07.2013), pages 2049-2056, XP032512439; Allak, E. et al.: “Covariance Pre-Integration for Delayed Measurements in Multi-Sensor Fusion”, 2019 IEEE/RSJ International Conference on Intelligent Robots and Systems (IROS), 3 Nov. 2019 (03.11.2019), pages 6642-6649, XP033695454. In addition, reference is made to the following documents: X. R. Li, Z. Zhao, and V. P. Jilkov, “Practical Measures and Test for Credibility of an Estimator,” Proc. Workshop on Estimation, Tracking, and Fusion, pages 481-495, 2001; W. J. Hughes, “Global positioning system (gps) standard positioning service (sps) performance analysis report,” Tech. Cntr. NSTB/WAAS T and E Team, no. 87, 2014; L. Serrano, D. Kim, R. B. Langley, K. Itani, and M. Ueno, “A gps velocity sensor: how accurate can it be?—a first look,” in ION N™, vol. 2004, 2004, pages 875-885.

### SUMMARY OF THE INVENTION

Proceeding from the aforementioned prior art, the object of the present invention is to provide a method, a system and a computer-readable storage medium for estimating state variables of a moving object, which enable dynamic and efficient integration of additional sensors added during the running time of the moving object. It is further an object of the present invention to provide a method, a system and a computer-readable storage medium for estimating state variables of a moving object, which allow a dynamic and efficient removal of sensors during the running time of the moving object.

The aforementioned objects are achieved by a computer-implemented method, a computer-readable storage medium and a data processing system having the features of the independent claims.

The running time is understood to be the time after the start-up of the moving object, wherein e.g. a stop (e.g. for refuelling or charging a moving object designed as a vehicle) is to be considered as taking place during the running time.

The addition of an additional sensor includes not only a physical addition (e.g. mounting) occurring after the start-up of the moving object, but inter alia also that the additional sensor is already present when the moving object is started up, but is switched on only after the start-up thereof and/or provides observation values only after the start-up. Accordingly, removing a sensor includes switching off and/or no longer providing observation values in addition to physical removal (e.g. demounting).

The computer-implemented method in accordance with the invention for estimating state variables of a moving object has the following steps: In a first step a), a recursive Bayesian filter used to estimate predefined core state variables of a moving object is initialized. The recursive Bayesian filter is preferably a recursive Kalman filter, in particular a so-called extended Kalman filter (EKF). The core state variables of the moving object are preferably navigation state variables, i.e. state variables relevant for navigation such as e.g. position, velocity and orientation.

In a subsequent step b), technical properties of the moving object are observed with the aid of one or a plurality of sensors, thus forming observation values (also called measurement values). Technical properties of a moving object are understood to mean in particular physical properties (such as e.g. position and velocity), biological properties and/or chemical properties.

In step c), the core state variables of the moving object and a covariance of the core state variables are temporally propagated by means of a state variable model of the recursive Bayesian filter using those observation values which have been formed with the aid of one or a plurality of sensors used since the start-up of the moving object. This can be e.g. one or a plurality of propagation sensors, i.e. sensors which provide relevant observations for core state variables designed as navigation state variables. In particular, it can be an inertial measurement unit (IMU).

If it is determined in a step d) that observation values are formed with the aid of an additional sensor added after the start-up of the moving object, then in a step e1) an initialization of a covariance of calibration state variables of the additional sensor and of cross-covariances of the core state variables of the moving object and the calibration state variables of the additional sensor is performed with the aid of the observation values formed by the additional sensor at a first time. The observation values formed by the additional sensor at the first time are the first observation values or the first measurement values which the additional sensor outputs.

If further observation values are formed or measurement values are output by the additional sensor at a second time which lies after the first time, then in a subsequent step e2) a covariance matrix of the recursive Bayesian filter is formed from (i) the covariance of the core state variables of the moving object, (ii) the latest covariance of the calibration state variables of the additional sensor and (iii) the latest cross-covariances of the core state variables of the moving object and the calibration state variables of the additional sensor. The covariance of the core state variables of the moving object is the covariance of the core state variables propagated to a time which is one time step before the second time (the second observation time).

In the first execution of step e2), the latest covariance of the calibration state variables of the additional sensor and the latest cross-covariances of the core state variables of the moving object and the calibration state variables of the additional sensor are the covariance and cross-covariances formed in sensor initialization step e1), respectively.

After forming the covariance matrix of the recursive Bayesian filter in step e2), the covariance matrix is updated or corrected in step e3) with the aid of the observation values formed by the additional sensor at the second time. In the subsequent step e4), the core state variables of the moving object are then calculated or estimated with the aid of the updated covariance matrix by means of the recursive Bayesian filter.

Thereafter, in step e5), the covariance of the calibration state variables of the additional sensor and the cross-covariances of the core state variables of the moving object and the calibration state variables of the additional sensor are separated from the covariance of the core state variables of the additional sensor and so separate processing/propagation can be effected.

If, after the second time, further observation values are formed by the additional sensor during later observations, the above steps e2) to e5) are repeated for these observation values at their respective later observation times. In step e2), in which the covariance matrix is formed, the covariance of the core state variables of the moving object which is propagated to a time step before the respective later time is used. The latest covariance of the calibration state variables of the additional sensor and the latest cross-covariances of the core state variables of the moving object and the calibration state variables of the additional sensor are then the covariance of the calibration state variables of the additional sensor likewise updated in the last update of the covariance matrix in the preceding step e3) and the updated cross-covariances of the core state variables of the moving object and the calibration state variables of the additional sensor.

According to a preferred embodiment, in the event that a plurality of additional sensors are added after start-up of the moving object, steps e1) to e6) of the method in accordance with the invention are carried out for each individual one of the added sensors. The covariances and cross-covariances associated with the respective additional sensors are preferably not updated at the same time. That is to say that no cross covariances are formed between different additional sensors added after start-up.

If, in the covariance matrix formed in step e2) of the method in accordance with the invention, the covariance of the core state variables of the moving object and the covariance and cross-covariances associated with the calibration states of the additional sensor are formed at different times, the covariance of the core state variables and the covariance and cross-covariances associated with the additional sensor do not contain the same amount of data, which can lead to a non-positive semi-definite and thus invalid covariance matrix. This is the case e.g. when the covariance and cross-covariances associated with the calibration states of the additional sensor relate to the first (observation) time, while the covariance of the core state variables of the moving object relates to a time which is one time step before the second (observation) time of the additional sensor. However, a non-positive semi-definite and thus invalid covariance matrix would lead to divergence and erroneous function of the recursive Bayesian filter in the longer term and so it is preferable to proceed as follows in order to avoid inconsistency associated with a non-positive semi-definite covariance matrix and divergence of the recursive Bayesian filter resulting from such inconsistency.

In order to address and solve the problem stated in the previous paragraph, according to a further preferred embodiment, in step e2) of the method in accordance with the invention, the latest covariance of the calibration state variables of the additional sensor and the latest cross-covariances of the core state variables of the moving object and the calibration state variables of the additional sensor are propagated to the same time as the covariance of the core state variables of the moving object with the aid of a series of one or a plurality of state transition matrices. In this way, all of the covariances and cross-covariances of the covariance matrix relate to the same time.

Here, the series of state-transition matrices Φ(m,n) between two times t(m) and t(n) is defined as follows:

Φ(m,n)=ΦₙΦₙ₋₁ . . . Φₘ

with t(m)<t(n) and Φₖ as a discrete state-transition matrix Φ_{k|k-1} which represents the state dynamics and is evaluated based on input values of the moving object and is integrated for the propagation step δt=t(k)−t(k−1) (cf. S. I. Roumeliotis and G. A. Bekey, “Distributed multirobot localization,” IEEE Transactions on Robotics and Automation, vol. 18, no. 5, pages 781-795, 2002).

Accordingly, the cross-covariance P_{CS} between the core state variables X_{C} of the moving object and the calibration state variables X_{S} of the additional sensor can be propagated from a time t(m) to a time t(n) as follows:

P_{CSn(-)}=Φ(m,n)P_{CSm}Φ(m,n)^{T}.

The same applies to the covariance of the calibration state variables of the additional sensor. The series of (time-developing) state-transition matrices calculated in this way and stored e.g. in a buffer can advantageously be used to propagate the covariance and cross-covariances associated with the additional sensor to the same time as the propagated covariance of the core state variables of the moving object. The covariances and cross-covariances associated with the additional sensor “inherit”, so to speak, during propagation the information they lacked for the time period during which only the covariance of the core state variables of the moving object had been propagated. By propagating the covariance of the core state variables alone for the time being, their complexity is advantageously kept independent of the number of additional sensors added after start-up and is thus kept constant. The covariances and cross-covariances associated with the additional sensors are preferably propagated only during formation of the covariance matrix.

If a plurality of additional sensors are added after start-up of the moving object, the situation can occur that observations from a first additional sensor indirectly influence the core state variables of the moving object and the calibration state variables of a second additional sensor by reason of cross-correlations, even though the first additional sensor has already been removed before the addition of the second additional sensor and has been added again only after removal of the second additional sensor. This undesired influence can lead to a non-positive semi-definite and thus invalid covariance matrix (a so-called pseudo-covariance matrix). By definition, covariance matrices are to be symmetric and positive semi-definite. This guarantees that their correlations or covariances are coherent.

According to a further preferred embodiment, in order to ensure that the covariance matrix formed in the method in accordance with the invention is positive semi-definite, the covariance matrix is corrected to a positive semi-definite covariance matrix prior to estimation of the core state variables of the moving object in step e3) of the method in accordance with the invention.

P. J. Rousseeuw and G. Molenberghs, “Transformation of non positive semidefinite correlation matrices,” Communications in Statistics—Theory and Methods, vol. 22, no. 4, pages 965-984, January 1993, available under: https://doi.org/10.1080/03610928308831068, and R. Rebonato and P. Jaeckel, “The most general methodology to create a valid correlation matrix for risk management and option pricing purposes,” SSRN Electronic Journal, 2011, available under: https://doi.org/10.2139/ssrn.1969689, describe various methods to estimate the closest positive semi-definite covariance matrix of a given pseudo-covariance matrix. The eigenvalue method and the scaling/hypersphere decomposition method with angular parametrization are described inter alia. The scaling/hypersphere decomposition method uses an optimization method to minimise the so-called Frobenius norm A:

A=ΣᵢⁿΣⱼⁿ(p_{i,j}−p_{i,j})²

with respect to a given matrix, where p are elements of the actual, given matrix and \tilde{p} are elements of its closest approximation.

The eigenvalue method approximates a positive semi-definite matrix by correcting the eigenvalues of a given matrix. According to N. J. Higham, “Computing a nearest symmetric positive semidefinite matrix,” Linear Algebra and its Applications, vol. 103, pages 103-118, May 1988, available under: https://doi.org/10.1016/0024-3795(88)90223-6, the eigenvalue method likewise minimises the Frobenius norm.

By reason of its deterministic properties and lower complexity, according to a preferred embodiment of the method in accordance with the invention, the covariance matrix formed is corrected into a positive semi-definite covariance matrix with the aid of an eigenvalue method. In the case of the eigenvalue method, the covariance matrix is decomposed into its eigenvalues and eigenvectors in a first step. In a second step, negative eigenvalues are corrected if necessary, and in a third step the covariance matrix is reconstructed with the corrected eigenvalues and the eigenvectors. That is to say that, in the first step, a covariance matrix P is decomposed as follows:

P=DRD^{T},

where R is a diagonal matrix with the eigenvalues and D are the eigenvectors. If the covariance matrix is non-positive semi-definite, then the eigenvalues R(<0) are negative and are preferably corrected. The negative eigenvalues can be corrected e.g. by one of the following eigenvalue methods: the absolute eigenvalue correction method, the zero eigenvalue correction method and the delta eigenvalue correction method.

In the case of the absolute eigenvalue correction method, a negative eigenvalue is replaced by its absolute value and so the dimensions spanned by the eigenvectors are retained. In the case of the zero eigenvalue correction method, a negative eigenvalue is replaced by the value zero, which represents the minimum change in order to obtain a positive semi-definite covariance matrix. In the case of the delta eigenvalue correction method, negative eigenvalues are replaced by positive empirical values. On account of consistency advantages, the absolute eigenvalue correction method is preferably used.

After correcting the eigenvalues, the covariance matrix is reconstructed based on the corrected eigenvalues and the eigenvectors and is used within the recursive Bayesian filter to estimate the core state variables of the moving object. A non-positive semi-definite and thus invalid covariance matrix would lead to divergence and erroneous function of the recursive Bayesian filter in the longer term, which makes the correction step described here indispensable in this method in accordance with the invention in order to enable in a dynamic and efficient manner the fusion of a plurality of sensors added even after start-up of the moving object or of their observation values.

The method in accordance with the invention for estimating (core) state variables of a moving object is a recursive method which enables in a dynamic and efficient manner the fusion of a plurality of sensors added even after start-up of the moving object or of their observation values. The same applies to the removal of sensors during the running time of a moving object. The present invention provides a robust, modular approach to multi-sensor data fusion (also) for sensors which are not known a priori either to the recursive Bayesian filter used to estimate the core state variables or to the moving object. Asynchronous and dynamic processing of the observations made at different times by the respective additional sensors is readily possible. This is of considerable advantage, in particular for long-term uses of moving objects, such as robot platforms.

FIG. 1 illustrates the modular approach of the present invention. FIG. 1a) shows a multi-sensor data fusion approach according to the prior art. The covariance matrix used contains, in addition to the covariance of the core state variables of the moving object, the covariances of the calibration states of two additional sensors A and B and the cross-correlations or cross-covariances between the core state variables of the moving object and the calibration state variables of sensors A and B. Thus, in the case of the prior art shown in FIG. 1a), the size and complexity of the covariance matrix increases with each additional sensor, and at each updating/correcting step the covariances and cross-covariances associated with all additional sensors are updated or corrected in addition to the covariance of the core state variables of the moving object.

FIG. 1b) illustrates the modular sensor fusion approach of the present invention, in which a segmentation of the covariance matrix is effected for each sensor. The covariance matrix is formed only for the additional sensor from which observation values are currently being obtained. Therefore, in the updating step, only the covariance of the core state variables of the moving object and the covariance and cross-covariances or cross-correlations associated with the respectively active additional sensor are updated/corrected with the new observations of this additional sensor. The same applies to the propagating step. Both, propagating and updating/correcting, are performed in a modular fashion, i.e. separately for each individual additional sensor, wherein the time duration for the execution of both the propagating step (propagating phase) and the updating step (updating phase or correcting phase) remains constant and independent of the number of additional sensors.

In FIG. 1b)—from left to right—firstly only observations from the additional sensor A, then only from the additional sensor B and finally again only from sensor A are supplied and used for updating the covariance matrix. The complexity and size of the covariance matrix advantageously remain independent of the number of additional sensors and remain constant.

In the case of the method in accordance with the invention, the efficient, subsequent addition of additional sensors is enabled by decoupling the core state variables of the moving object from the calibration states of the respective additional sensors, whereby the core state variables of the moving object and the calibration state variables of the respective additional sensors can each be propagated independently of each other. In the case of the method in accordance with the invention, the subsequently added, additional sensors are continuously self-calibrated. As a result, the method in accordance with the invention is characterised by a high degree of flexibility with low required computing power.

Therefore, in the case of the method in accordance with the invention the complexity overall is only linearly dependent on the number of additional sensors. In the propagating step, the complexity even remains substantially constant. The method in accordance with the invention thus requires considerably less computing power than the methods known from the prior art and can consequently process observations more rapidly than known methods, which in turn enables more precise navigation or control of the moving object with the same computing power. Alternatively or additionally, the saved computing power can be used e.g. to increase the range of the moving object. Alternatively, less powerful and generally less expensive processors can be used.

At the same time, the consistency and observability of the recursive Bayesian filter used are maintained in the method in accordance with the invention, in particular by virtue of the fact that the covariance matrices are kept consistent and positive semi-definite despite modular treatment. With the aid of the invention, additional sensors added after start-up can be efficiently initialized and calibrated in relation to the respective moving object. Overall, an increase in efficiency of 30% was observed in the method in accordance with the invention compared to known methods. A decentralised implementation of the method in accordance with the invention which requires less bandwidth than a centralised implementation is readily possible. Calibration state variables of the additional sensors can be locally stored and propagated and updated.

The present invention can be used e.g. in the technical fields of robotics, automation and in the automotive and vehicle industry, wherein the term “vehicle” includes not only automobiles but also aircraft and watercraft. Owing to its comparatively low complexity, the method in accordance with the invention is particularly suitable for use in autonomous vehicles with limited dimensions and limited computing power, such as e.g. drones (unmanned aerial vehicles, UAV).

By reason of the above-described segmentation of the covariance matrix for each additionally added sensor and the thereby associated suitability for processing asynchronous observations, the present invention is also particularly suitable for processing delayed observations or measurement data, not originally planned, “out-of-sequence” updates/corrections to the covariance matrix, and sensor health monitoring.

The present invention also relates to a computer-readable storage medium comprising instructions which, when executed by a computer, cause the computer to perform the method in accordance with the invention. The advantages of the method in accordance with the invention are achieved by the computer-readable storage medium. The present invention also relates to a data processing system which comprises means for carrying out the method in accordance with the invention. The means are configured to instantiate one or a plurality of sensor components representing one or a plurality of additional sensors added after start-up of a moving object, and further to instantiate a filter component representing a recursive Bayesian filter, wherein the filter component is dependent on the execution of the recursive Bayesian filter.

With the data processing system in accordance with the invention, a modular implementation of the method in accordance with the invention can be achieved which renders it possible in a simple and efficient manner to take into consideration additional sensors by instantiating corresponding components (also called modules, instances) and to then remove them when the respective sensors are removed. Furthermore, the data processing system in accordance with the invention enables a rapid and uncomplicated change of the recursive Bayesian filter used by simply changing or re-instantiating the filter component representing it.

### BRIEF DESCRIPTION OF THE DRAWINGS

Further advantageous embodiments of the invention will be apparent from the dependent claims and the exemplified embodiments presented hereinafter with reference to the drawings. In the drawing:

FIG. 1 shows a schematic comparison of the covariance matrix of a recursive Bayesian filter which is used for estimating core state variables and is designed as a Kalman filter according to the prior art (FIG. 1a)) and according to the method in accordance with the invention (FIG. 1b)),

FIG. 2 shows an exemplified embodiment of the method in accordance with the invention having, by way of example, two additional sensors,

FIG. 3 shows a schematic view of an example of a calibration of calibration state variables of additional sensors according to the method in accordance with the invention,

FIG. 4 shows an example of a flight profile of an application example of the method in accordance with the invention in the form of a drone,

FIG. 5 shows an example of an implementation of the method in accordance with the invention and

FIG. 6 shows an example of a structure of a buffer entry.

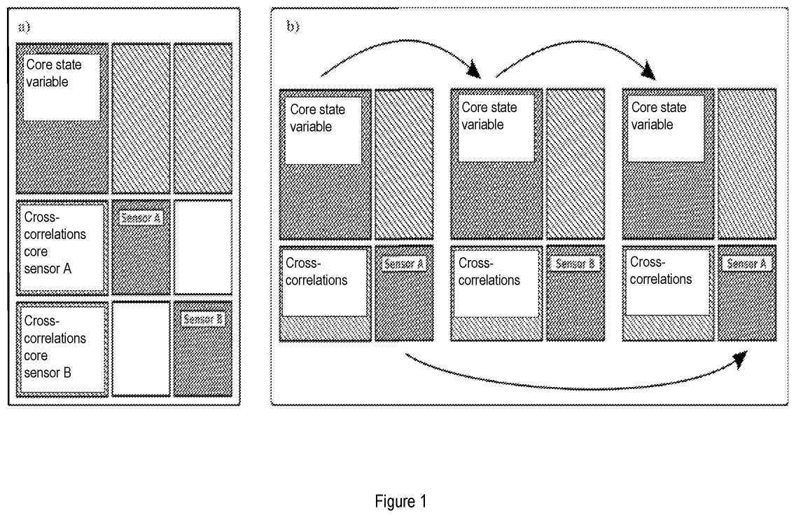

FIG. 1 is described in connection with the description of the advantages of the invention in the introductory part of the description above. Reference is made to the passages of text therein.

### DESCRIPTION OF THE EXEMPLIFIED EMBODIMENTS

In order to control and regulate a moving object, core state variables of the moving object are typically defined in advance and describe the essential variables of the moving object. For a moving object which comprises e.g. an inertial measurement unit (IMU) or on which an IMU is provided, the core state variables are in particular navigation state variables, such as the position of the object-related coordinate system (body frame) p_{WI}, which is defined in relation to a reference coordinate system (world frame), the velocity v_{WI} of the inertial measurement unit in relation to the reference coordinate system, the orientation of the inertial measurement unit in relation to the reference coordinate system q_{WI}, the gyroscopic bias b_{ω} and the acceleration bias bₐ. The object-related coordinate system and the reference coordinate system are defined as same-handed, preferably right-handed. The position and orientation of the object-related coordinate system corresponds preferably to the position and orientation of the inertial measurement unit in relation to the reference coordinate system. This results in the following (core) state variable matrix X_{C}:

X_{C}=[p_{WI}^{T},v_{WI}^{T},q_{WI}^{T},b_{ω}^{T},bₐ^{T}]^{T}. (1)

Moving objects can be represented fundamentally by mathematical, time-dependent models which propagate the core state variables and their covariances to the next time and which are based on the core state variables measured by the inertial measurement unit. The following differential equations describe such a mathematical model, also called a state space model, which represents the core state variables:

\dot{p}_{WI}=v_{WI} (2)

\dot{v}_{WI}=R_{(q}_{_{WI}}₎(aₘ−bₐ−nₐ)−g (3)

\dot{q}_{WI}=½Ω(ωₘ−b_{ω}−n_{ω})q_{WI} (4)

\dot{b}_{ω}=n_{b}_{_{ω}},\dot{b}ₐ=n_{b}_{ₐ}. (5)

In this case, aₘ is a measurement value of the inertial measurement unit of the linear acceleration of the moving object, bₐ is the bias of the linear acceleration of the moving object, nₐ is measurement noise of the linear acceleration, g is the gravitational constant, ωₘ is a measurement value of the inertial measurement unit of the angular velocity of the moving object, b_{ω} is the bias of the angular velocity of the moving object, and n_{ω} is the measurement noise of the angular velocity. Furthermore, R and Ω(ω) are defined as follows, where Ω(ω) is the right-hand side quaternion multiplication matrix:

$$R = [ \begin{matrix}{q}_{w}^{2} + {q}_{x}^{2} - {q}_{y}^{2} - {q}_{z}^{2} & 2 ( {q}_{x} {q}_{y} - {q}_{w} {q}_{z} ) & 2 ( {q}_{x} {q}_{z} + {q}_{w} {q}_{y} ) \\ 2 ( {q}_{x} {q}_{y} + {q}_{w} {q}_{z} ) & {q}_{w}^{2} - {q}_{x}^{2} + {q}_{y}^{2} - {q}_{z}^{2} & 2 ( {q}_{y} {q}_{z} - {q}_{w} {q}_{x} ) \\ 2 ( {q}_{x} {q}_{z} - {q}_{w} {q}_{y} ) & 2 ( {q}_{y} {q}_{z} + {q}_{w} {q}_{x} ) & {q}_{w}^{2} - {q}_{x}^{2} - {q}_{y}^{2} + {q}_{z}^{2}\end{matrix} ]$$

$$Ω ( ω ) {=}^{Δ} {[ ω ]}_{R} = [ \begin{matrix}0 & - {ω}^{T} \\ ω & - {[ ω ]}_{x}\end{matrix} ] = [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & {ω}_{y} & - {ω}_{x} & 0\end{matrix} ]$$

The following applies in relation to R:

_{C}P_{AB}=R_{(q}_{_{CA}}₎_{^{A}}p_{AB}

R_{(q}_{_{CA}}₎≡RCA

If additional sensors are to be added or taken into consideration during the running time of the moving object, they are usually not oriented with the moving object. Such additional sensors or their extrinsic properties can be inserted into the above model as calibration state variables, wherein the calibration state variables can be estimated. For example, if two additional sensors S₁ and S₂ are added to the moving object during its running time, i.e. after it has started up, the core state variables X_{C} can be extended by the calibration state variables X_{S1} and X_{S2} as follows:

The observation of the additional sensors or their calibration state variables e.g. by means of a recursive Bayesian filter designed as an extended Kalman filter, leads to cross-correlations between the core state variables and the calibration state variables of the additional sensors and thus to cross-covariances in the covariance matrix P of the recursive Bayesian filter. After observations by the additional sensors S₁ and S₂ added during the running time, the following covariance matrix P is provided:

$$P = [ \begin{matrix}{P}_{C} & {P}_{CS 1} & {P}_{CS 2} \\ {P}_{S 1 C} & {P}_{S 1} & 0 \\ {P}_{S 2 C} & 0 & {P}_{S 2}\end{matrix} ] \qquad ( 7 )$$

wherein P_{CS2}=(P_{SC2})^{T} (accordingly for the additional sensor S₁) and the equation (7) is based on the assumption that the additional sensors S₁ and S₂ are independent of each other, i.e. do not influence each other. This is the case e.g. for a GNSS (Global Navigation Satellite System) sensor and a sensor designed as a camera. Position and positional calibration of the GNSS sensor (or a GPS sensor) with respect to the moving object (e.g. a vehicle) are independent of the position of the camera on the moving object. The same applies to a magnetometer with three degrees of freedom and a GNSS sensor with three degrees of freedom. The rotational calibration of the magnetometer in relation to the object-related coordinate system, in which the position of the inertial measurement unit is defined and the translation of the GNSS sensor in relation to the object-related coordinate system or the inertial measurement unit are not physically related to each other. Even if cross-correlations should exist from an analytical point of view, these and the decrease in accuracy associated with them being taken into consideration are negligible compared to the increase in computational speed when these cross-correlations are omitted.

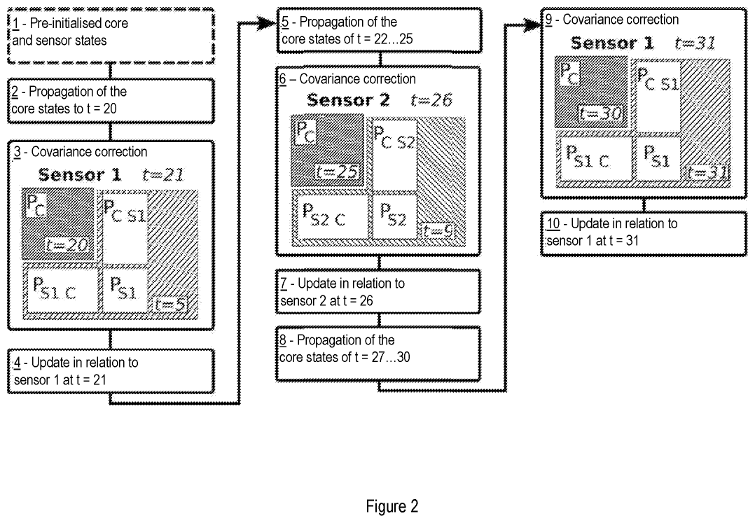

FIG. 2 shows an exemplified embodiment of a method in accordance with the invention for the case of two additional sensors 1 and 2 added after start-up. The time period between the times t=0 and t=31 is shown by way of example. In FIG. 2, fields with positive slope hatching relate to the additional sensor 1, fields with negative slope hatching relate to the additional sensor 2 and fields with diamond hatching relate to the core state variables. Blocks 3, 6 and 9 of FIG. 2 each show the covariance matrix at different times divided into its individual (covariance and cross-covariance) segments which are processed separately according to the method in accordance with the invention (cf. also FIG. 1). The examples of observation times of the sensors 1 and 2 shown in FIG. 2 are dependent on the measurement data of the additional sensors used.

At time t=0, the moving object is started up and the recursive Bayesian filter used to estimate the state variables and the predefined core state variables of the moving object are initialized (block 1 in FIG. 2).

After start-up, two additional sensors are added during the running time of the moving object: The sensor 1 is added at time t=5. The sensor 2 is added at time t=9. If it is determined that additional sensors have been added or if observation values are formed by these additional sensors, the covariance of the calibration state variables of the respective additional sensor and the cross-covariances of the core state variables of the moving object and the calibration state variables of the respective additional sensor are initialized or calibrated with the aid of the observation values formed at the time of the addition. That is to say that in the present example, the covariance and cross-covariances associated with the additional sensor 1 are initialized/calibrated at time t=5 (likewise block 1 of FIG. 2), while the covariance and cross-covariances associated with the additional sensor 2 are initialized/calibrated at time t=9 (likewise block S1 of FIG. 2). If the additional sensor 1 is e.g. a GPS sensor, the position of the GPS sensor in the object-related coordinate system of the moving object is calibrated at time t=5.

Independently of the initialization of the additional sensors 1 and 2, the core state variables and their covariance are propagated up to one time step before the next time, at which one of the additional sensors 1 and 2 outputs/forms next observation values. In this example, this is time t=20, because at time t=21, the additional sensor 1 forms observation values once again (block 2 in FIG. 2).

At time t=21, the latest covariance P_{S1} associated with the additional sensor 1 and the associated latest cross-covariances P_{CS1} are now combined with the latest covariance Pc of the core state variables of the moving object to form the covariance matrix P. Here, the latest covariance P_{S1} associated with the additional sensor 1 and the latest cross-covariances P_{CS1} are the covariance P_{S1} initialized at time t=5 and the cross-covariances P_{CS1} initialized at time t=5. The covariance Pc of the core state variables corresponds to the covariance Pc propagated to time t=20 (cf. block 3 in FIG. 2).

Preferably, in order to form the covariance matrix P, the latest covariance P_{S1} associated with the additional sensor 1 and the associated latest cross-covariances P_{CS1} are propagated to the same time as the covariance of the core state variables, i.e. to t=20, with the aid of a series of state transition matrices as described above. Furthermore, the covariance matrix P is preferably corrected into a positive semi-definite covariance matrix, if necessary, as described above, in particular by using an eigenvalue method. Finally, the formed covariance matrix (or its segments) is buffered (likewise block 3 of FIG. 2).

With the covariance matrix formed in block 3, an update or correction of the covariance matrix is now carried out in block 4 with the observations of the additional sensor 1 formed at time t=21. The updated covariance matrix is then used to estimate core state variables. Thereafter, the covariance associated with the additional sensor 1 and the associated cross-covariances are separated from the covariance of the core state variables (block 4 in FIG. 2).

In block 5 of FIG. 2, the core state variables or their covariance are propagated until one time step before the next observation values are received at time t=26. That is to say the covariance of the core state variables is propagated from time 22 to time t=25. In the present example, the next observation values are output by the additional sensor 2 at time t=26.

In block 6, in order to update the covariance matrix by means of the observation values obtained at time t=26, the covariance matrix is formed once again from: the covariance of the core state variables propagated to time t=25 and the covariance and cross-covariances initialized at time t=9 and associated with the additional sensor 2 (block 6 of FIG. 2). Also, in block 6, preferably in order to form the covariance matrix, the latest covariance and cross-covariances associated with the additional sensor 2 are propagated to the same time as the covariance of the core state variables, i.e. to t=25, with the aid of a series of state-transition matrices. Furthermore, the covariance matrix is preferably corrected into a positive semi-definite covariance matrix, if necessary, in particular by using the eigenvalue method. Finally, the formed covariance matrix (or its segments) is buffered (likewise block 6 of FIG. 2).

In block 7, the covariance matrix formed in block 6 is then updated or corrected with the aid of the observation values of the additional sensor 2 obtained at time t=26, and the core state variables are estimated with the updated covariance matrix. Thereafter, the covariance and cross-covariances associated with the additional sensor 2 are then separated from the covariance of the core state variables (block 7 in FIG. 2).

In blocks 8 to 10 of FIG. 2, the method in accordance with the invention continues as described above. Next, observation values are obtained from the additional sensor 1 at time t=31. Accordingly, the covariance of the core state variables is propagated from time t=27 to time t=30. From the covariance of the core state variables propagated in this way and the latest covariance and cross-covariances associated with the sensor 1 (from time t=21; see description of block 4), the covariance matrix is formed which is then updated or corrected in block 10 with the observation values from additional sensor 1 at time t=31 and used to estimate the core state variables.

Also, in block 9, preferably in order to form the covariance matrix, the latest covariance and cross-covariances associated with the sensor 1 are propagated to the same time as the covariance of the core state variables, i.e. to t=30, with the aid of the series of state-transition matrices. Furthermore, the covariance matrix is preferably corrected to a positive semidefinite covariance matrix, if necessary, in particular by using the eigenvalue method. Finally, the formed covariance matrix (or its segments) is buffered (block 9 of FIG. 2) before being updated in block 10.

That is to say that in the case of the method in accordance with the invention, the core state variables (or their covariance) are advantageously propagated separately from the calibration state variables of the sensors (or their covariance and cross-covariances with the core state variables). The calibration state variables of the additional sensors (or their covariance and cross-covariances with the core state variables) are again initialized/calibrated separately from the core state variables and updated separately from one another. Thus, with the present invention, additional sensors added after start-up can be taken into consideration without influencing the covariances and cross-covariances of other sensors associated with the core state variables.

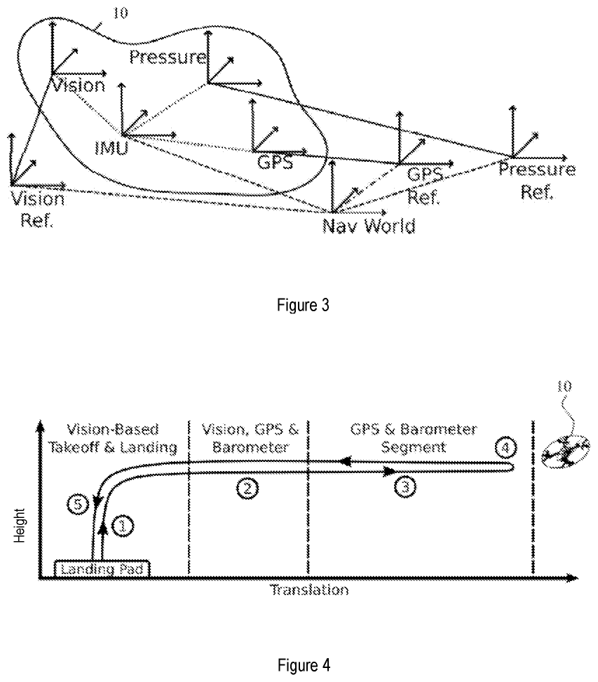

FIG. 3 schematically shows an initialization/(self-)calibration of examples of calibration state variables of additional sensors which are subsequently added in a moving object 10 comprising an inertial measurement unit IMU. The moving object 10 and the inertial measurement unit (IMU) are arranged in a reference coordinate system “Nav World”. After start-up of the moving object 10, additional sensors are added in the form of a vision sensor (“Vision” e.g. a camera), a pressure sensor (“Pressure” e.g. a barometer) and a GPS sensor. The observations of these sensors relate to the respective sensor coordinate systems (“Vision Ref.”, “Pressure Ref.”, “GPS Ref.”) as indicated by solid lines in FIG. 3. The coordinate system “GPS Ref.” of the GPS sensor is a specified global coordinate system which is fixed and defined in relation to the reference coordinate system “Nav World” (dash-dotted line in FIG. 3). The dashed lines between the sensor coordinate systems “Vision Ref.” and “Pressure Ref” indicate their position and orientation in relation to the reference coordinate system “Nav World”. The dashed line between the IMU and the reference coordinate system indicates the position and orientation of the object-related coordinate system in relation to the reference coordinate system “Nav World”. The dotted lines between the vision, pressure and GPS sensors and the IMU representing the moving object 10 indicate the initialization/calibration of the calibration state variables of the additional sensors in relation to the object-related coordinate system of the moving object 10 or of its IMU, as described above in connection with block 1 of FIG. 2, in the context of the method in accordance with the invention.

FIG. 4 shows an application example associated with FIG. 3, in which the moving object is designed as a drone 10. FIG. 4 shows an example of a flight profile of the drone 10. The flight profile contains different phases 1, 2, 3, 4, 5, in which different additional sensors (or their measurement data/observation values) are added or removed. For instance, the vision sensor is used in phase 1 (take-off from the landing pad) and phase 2 (straight flight). In phase 2, the pressure sensor (barometer) and the GPS sensor are added which are also used in phase 3 (turning). However, in phase 3 the vision sensor is not used and is switched off. It is only switched on again when returning to phase 2 and calibrated/initialized to the current position of the drone 10. Then, after a short overlap period, the pressure sensor and the GPS sensor are deactivated and so they are no longer taken into consideration when entering the final phase 5. In phase 5, in this example, the landing on the landing pad is effected solely by means of the vision sensor. Instead of a GPS sensor, another GNSS sensor can, of course, also be used.

An additional sensor can also be designed as another drone or a sensor which is provided on or associated with another drone, e.g. as a camera installed on another drone which films the drone of which the core state variables are to be estimated.

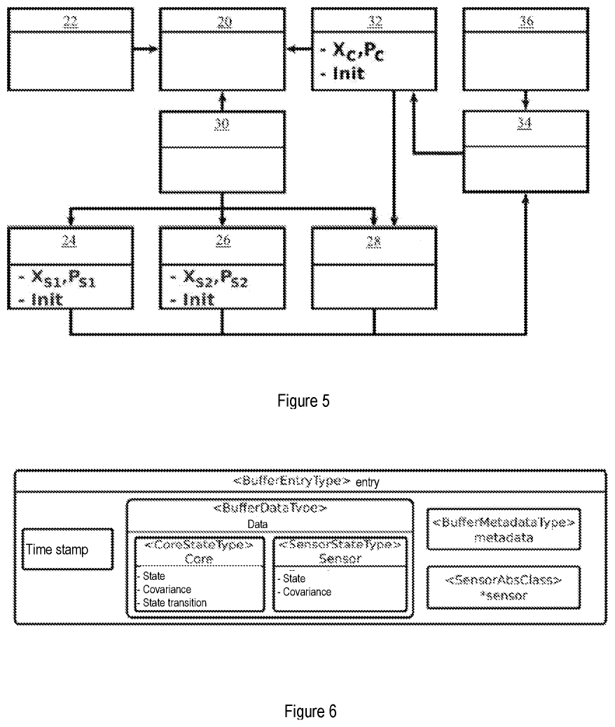

FIG. 5 shows an example of a modular implementation of the method in accordance with the invention. The implementation can be effected by means of software components and/or hardware components. Each of the components (also called module, instance or unit) is preferably designed independently with clearly defined interfaces to enable simple and efficient interchangeability of the respective component.

Preferably, a core logic component 20 (also called main logic component) is provided, which is responsible for the organisational part when the method in accordance with the invention is being performed, and forms the interface between the buffer 22 and the sensor components 24, 26, 28. The sensor components 24 and 26 represent or instantiate additional sensors which are switched on after start-up, such as e.g. a GPS sensor 24 and a vision sensor 26 (e.g. a camera). The sensor component 28 preferably represents a sensor which is already switched on during start-up, such as e.g. a propagation sensor, i.e. a sensor which provides observations relevant to the core state variables. If the core state variables are navigation state variables, the propagation sensor can be designed e.g. as an IMU.

The core logic component 20 is configured in particular in such a way that it verifies the usefulness of the observation values formed by the sensors and, if necessary, does not take them into consideration for an estimation of the state variables if there is no longer any usefulness e.g. in the case of greatly delayed observations/measurement values, of which the delay exceeds a predefined period of time or of which the observation time (time stamp) is older than the last buffer entry.

FIG. 6 shows an example of an entry in the buffer 22 for an additional sensor. In addition to an identification of the respective additional sensor, the time of the last observations (time stamp) and the following data/values determined at this time stamp are stored in the buffer: the core state variables, the covariance of the core state variables, the calibration state variables of the respective additional sensor, the covariance of the calibration state variables, the cross-covariances between the core state variables and the calibration state variables and the state-transition matrices. Furthermore, metadata are stored.

Referring again to FIG. 5, a sensor manager 30 is preferably provided which preferably has a list of all sensors and is responsible for the management of the sensor components 24, 26, 28 at a higher level.

Furthermore, an independent core state variable component 32 is preferably provided, to which the core logic component 20 relays observations of the sensor 28 already switched on during the start-up of the moving object. The core state variable component 32 is configured to propagate the core state variables (core state variable vector) and their covariance based on these observations, as described above. The propagated core state variables and their covariances are stored in the buffer 22.

If current observations come from an additional, subsequently added sensor, the core state variable component 32 also calculates individual state-transition matrices for each individual propagation step. The individual state transition matrices are then likewise stored in the buffer 22.

Upon receipt of current observation values from an additional sensor, the core logic component 20 requests the last or latest entry in the buffer 22 and calculates the series of state-transition matrices starting from the time stamp of the retrieved buffer entry to one time step before the time of the current observations. The sensor component 24, 26 corresponding to the respective additional sensor propagates the covariance of the calibration state variables of the additional sensor retrieved from the buffer 22 and the retrieved cross-covariances between calibration state variables and core state variables to a time step prior to the observation time of the current observation values with the aid of the calculated series of state-transition matrices.

From this propagated covariance of the calibration states of the additional sensor and the correspondingly propagated cross-covariance associated with the additional sensor and the propagated covariance of the core state variables, the covariance matrix is then formed, preferably in the core logic component 20, and is then corrected, likewise by the core logic component 20, if necessary using the eigenvalue method, in order to obtain a positive semi-definite covariance matrix which is then passed on to the respective sensor component 24, 26. Then, the covariance matrix is updated/corrected with the latest observations of the respective additional sensor in the sensor component 24, 26 associated with it. Advantageously, additional static tests such as e.g. a χ²-test can be carried out by the respective sensor component 24, 26. The covariance matrix or its (covariance and cross-covariance) segments updated in the respective sensor component 24, 26 are then transmitted via the sensor manager 30 to the core logic component 20 which relays the segments to the buffer 22 for storage purposes.

Furthermore, a filter component 36 is provided which represents or instantiates a recursive Bayesian filter. By way of example, the filter component 36 represents a Kalman filter, in particular an extended Kalman filter. By reason of the modular implementation/instantiation of the recursive Bayesian filter, its specific configuration can be changed in a simple and efficient manner, e.g. from an extended Kalman filter to another recursive Bayesian filter, e.g. a so-called unscented Kalman filter.

In order to estimate the core state variables, the sensor components 24, 26, 28 and the filter components 34 are derived, preferably by software, from an abstract sensor component 34. This has the advantage that sensor components for additional sensors can be added, removed and replaced simply and efficiently.

The implementation of the method in accordance with the invention as shown in FIG. 5 has the advantage that the core state logic component 20 does not need to have any knowledge of the sensors and can be implemented independently thereof, so to speak. All “sensor knowledge”, such as e.g. mathematical definitions of the respective sensor models and the methods—to be submitted for the respective sensors—for initializing/calibrating, generating and handling their calibration states including their propagation, updating and correction is contained in the sensor components 24, 26, 28. This advantageously allows the efficient and elegant addition or switching-on of additional sensors even after start-up. Each sensor component is independent and independently calculates the covariance and cross-variance associated with it both during initialization and propagation, as well as during updating/correction, wherein, in particular during initialization, the core state variables applicable at time thereof can be obtained via the core logic component 20 and thus taken into consideration.

What is claimed is:

1. A computer-implemented method for estimating state variables of a moving object, characterised by the following steps:
a) initializing a recursive Bayesian filter to estimate predefined core state variables of the moving object,
b) observing technical properties of the moving object with the aid of one or a plurality of sensors, with observation values being formed,
c) temporally propagating the core state variables of the moving object and a covariance of the core state variables by means of a state variable model of the recursive Bayesian filter using the observation values which have been formed with the aid of one or a plurality of sensors used since start-up of the moving object,
d) determining whether secondary observation values are formed with the aid of an additional sensor added after start-up of the moving object,
e) if in step d) it has been determined that secondary observation values are formed with the aid of the additional sensor added after start-up of the moving object,
e1) initializing a covariance of calibration state variables of the additional sensor and cross-covariances of the core state variables of the moving object and the calibration state variables of the additional sensor with the aid of the secondary observation values formed by the additional sensor at a first time,
e2) during formation of the secondary observation values by the additional sensor at a second time after the first time: forming a covariance matrix of the recursive Bayesian filter from the covariance of the core state variables of the moving object propagated to a time which is one time step before the second time, the latest covariance of the calibration state variables of the additional sensor and the latest cross-covariances of the core state variables of the moving object and the calibration state variables of the additional sensor,
e3) updating the covariance matrix with the aid of the secondary observation values formed at the second time by the additional sensor,
e4) ascertaining the core state variables of the moving object with the aid of the updated covariance matrix of the recursive Bayesian filter,
e5) separating the covariance of the calibration state variables of the additional sensor and the cross-covariances of the core state variables of the moving object and the calibration state variables of the additional sensor from the covariance of the core state variables of the additional sensor,
e6) repeating steps e2) to e5) for secondary observation values of the additional sensor which are formed at later times after the second time, wherein in step e2) the covariance of the core state variables of the moving object is propagated to a time which is one time step before the respective later time.

2. The method as claimed in claim 1, wherein steps e1) to e6) are performed for each additional sensor added after start-up of the moving object.

3. The method as claimed in claim 1, wherein in step e2) the latest covariance of the calibration state variables of the additional sensor and the latest cross-covariances of the core state variables of the moving object and the calibration state variables of the additional sensor are propagated to the same time as the covariance of the core state variables of the moving object with the aid of a series of one or a plurality of state-transition matrices.

4. The method as claimed in claim 3, wherein prior to performing step e3) the formed covariance matrix is corrected to a positive semi-definite covariance matrix.

5. The method as claimed in claim 4, wherein the formed covariance matrix is corrected to a positive semi-definite covariance matrix with the aid of an eigenvalue method, in which the covariance matrix is i) decomposed into its eigenvalues and eigenvectors, ii) if necessary, negative eigenvalues are corrected, and iii) the covariance matrix is reconstructed with the corrected eigenvalues and the eigenvectors.

6. The method as claimed in claim 5, wherein the negative eigenvalues are corrected by the absolute eigenvalue correction, the zero eigenvalue correction or the delta eigenvalue correction.

7. The method as claimed in claim 1, wherein the recursive Bayesian filter is configured as a Kalman filter.

8. The method as claimed in claim 7, wherein the Kalman filter is an extended Kalman filter.

9. A computer-readable storage medium comprising instructions which, when executed by a computer, cause the computer to carry out a method as claimed in claim 1.

10. A system for data processing, comprising means for carrying out a method as claimed in claim 1, wherein the means are configured to instantiate one or a plurality of sensor components which represent one or a plurality of additional sensors added after start-up of a moving object, and
to instantiate a filter component which represents a recursive Bayesian filter, wherein the filter component is dependent on the execution of the recursive Bayesian filter.
